(19) United States
(12) Patent Application Publication
(10) Pub. No.: US 2025/0245768 A1
(43) Pub. Date: Jul. 31, 2025

(54) METHOD AND SYSTEM FOR MANAGING FLEET AND SERVER EMPLOYING METHOD

(71) Applicant: HON HAI PRECISION INDUSTRY CO., LTD., New Taipei (TW)

(72) Inventors: TSUNG-WEI LIU, New Taipei (TW); CHIN-PIN KUO, New Taipei (TW)

(21) Appl. No.: 19/027,305

(22) Filed: Jan. 17, 2025

(30) Foreign Application Priority Data
Jan. 25, 2024 (CN) 202410109481.3

(51) Int. Cl. G06Q 50/40; G06Q 50/26; G07C 5/00; G07C 5/06

(52) U.S. Cl. CPC G06Q 50/40; G06Q 50/265; G07C 5/008; G07C 5/06

(57) ABSTRACT

A fleet management method for managing a plurality vehicles of a fleet includes: receiving objective driving data from an on-board computer of a vehicle of the fleet; detecting whether the vehicle of the fleet exists a dangerous driving behavior in accordance with the objective driving data to generate a detection result; and determining a management strategy of the vehicle of the fleet in accordance with the detection result. A fleet management system and a server are also provided.

### TECHNICAL FIELD

The subject matter herein generally relates to fleet managements.

### BACKGROUND

In a fleet management, an on-board equipment of each vehicle in the fleet collects data generated during a driving of the vehicle, and uploads the collected data to the server for storing and analyzing, so as to realize an intelligent management of the fleet.

However, when the fleet includes more and more vehicles, the amount of data generated by vehicles in the fleet is large, and the collected data may occupy too much network communication resources, easily cause a network congestion, increase a cost of data upload, and also consume too much computing resources of the server for processing data.

### BRIEF DESCRIPTION OF THE DRAWINGS

Implementations of the present disclosure will now be described, by way of embodiments, with reference to the attached figures.

FIG. 1 is a scenario diagram illustrating a fleet management system according to an embodiment of the present disclosure.

FIG. 2 is a block diagram illustrating the fleet management system of FIG. 1 according to an embodiment of the present disclosure.

FIG. 3 is a flowchart illustrating a fleet management method according to an embodiment of the present disclosure.

FIG. 4 is a block diagram illustrating a server according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure. It should be noted that references to “an” or “one” embodiment in this disclosure are not necessarily to the same embodiment, and such references mean “at least one”.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

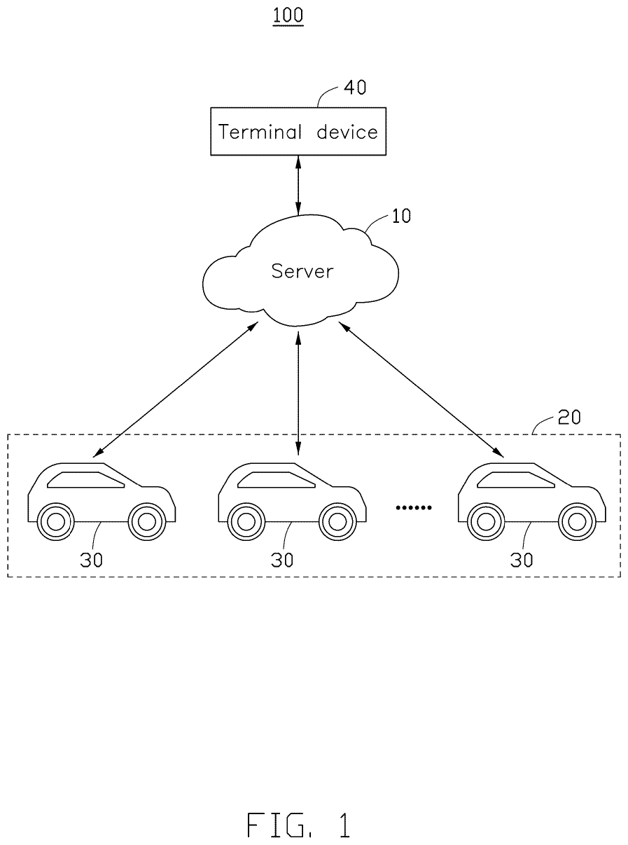

FIG. 1 illustrates one exemplary embodiment of a fleet management system 100.

The fleet management system 100 may include a server 10, the server 10 can manage a plurality of vehicles 30 in a fleet 20.

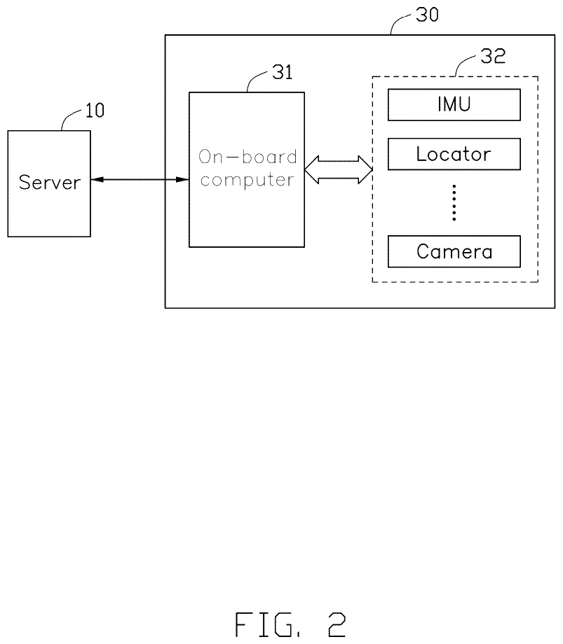

Referring to FIG. 2, each vehicle 30 in the fleet 20 is configured with an on-board computer 31, the sever can communicate with the on-board computer 31 in each vehicle 30.

In one embodiment, each vehicle 30 in the fleet 20 is further configured with a data collecting device 32. The data collecting device 32 is configured to collect initial driving data of the vehicle 30. The initial driving data may include a plurality of driving parameters collected by the data collecting device 32 in a driving process of the vehicle 30.

For example, the initial driving data may include speeds, accelerations, current positioning information, distances between the vehicle and another vehicle in front, light switch states, driving road images, driving direction, etc.

Date type included in the initial driving data can be configured according to an actual application requirement, and the vehicle can be configured different types of data collecting device 32 to collect the different data types of the initial driving data. Such as, the data collecting device 32 may include: inertial measurement unit (IMU), locators (such as global position system), radar sensors, cameras, etc.

The initial driving data can be configured to indicate a driving environment and a driving state of the vehicle 30, and/or a state of a driver of the vehicle.

The state of the driver may include whether the drivers answers a phone, and whether the driver yawns during driving the vehicle 30, and a continuous driving time.

The driving state of the vehicle 30 can include a turning situation, a speed, an acceleration, etc.

The driving environment of the vehicle 30 may include a static scene attribute and a dynamic scene attribute of a road during the vehicle 30 driving.

For example, the static scene attribute may include whether the vehicle 30 is driving on a one-way road, whether the vehicle 30 is driving at an intersection, whether the road is configured with a speed limit, and a driving direction of a lane which the vehicle 30 need to follow.

In one embodiment, the static scene attribute can be determined in accordance with the current position information of the vehicle 30 and a high-precision map including the current position information.

In one embodiment, the high-precision map may include a wealth of road elements and traffic-related dynamic elements, such as detailed lane markings, road signs, traffic signs, traffic lights, lane curvatures, slopes, and lane-level traffic dynamic information in real-time. Therefore, the static scene attribute of the vehicle 30 can be accurately obtained in accordance with the high-precision map and the current positioning information of the vehicle 30.

The dynamic scene attribute may include: red/green light signal of the road during the vehicle 30 driving, positions of pedestrians around the vehicle 30, distances between the vehicle 30 and another vehicle in front, etc.

In one embodiment, the dynamic scene attribute can be determined in accordance with the driving road images in the initial driving data.

In one embodiment, the on-board computer 31 can communicated with the data collecting device 32 through communication buses inside the vehicle 30, to obtain the initial driving data collected by the data collecting device 32. For example, the on-board computer 31 can communicated with the data collecting device 32 through one or more communication buses, such as local interconnect network (LIN) buses, controller area network (CAN) buses, FlexRay buses, media oriented system transport (MOST) buses.

The on-board computer 31 is configured to obtain the initial driving data of the vehicle 30, determine objective driving data from the initial driving data, and transmit the objective driving data to the server 10. Each vehicle can determine the objective driving data and transmit the objective driving data to the server 10 through its own on-board computer 31.

The objective driving data can be driving data that screen from the initial driving data to transmit to the server 10.

Screening strategy of the objective driving data can be set according to the actual application requirement. For example, speed-related driving data can be screened as the objective driving data from the initial driving data, or driving data within a preset time can be screened as the objective driving data from the initial driving data.

In one embodiment, the on-board computer 31 may screen driving data that exists a preset potential dangerous event from the initial driving data as the objective driving data.

Furthermore, if the on-board computer 31 identifies driving data with the preset potential danger event in the initial driving data, the on-board computer 31 can further determine an occurring time segment of the potential danger event, and define the driving data within the occurring time segment as the objective driving data.

For example, the potential danger event may include a sharp acceleration, a sharp deceleration, suddenly and drastically changing a driving direction of the vehicle 30 at a high speed, changing the driving direction of the vehicle 30 several time in a short time (such as serpentine driving), changing lanes without a turn signal, a continuous driving time of the driver being a first time, the driver yawning many times, and a continuous eye closure being a second time during the vehicle 30 driving.

After the on-board computer 31 screens out the objective driving data, the on-board computer 31 further transmits the objective driving data to the server 10.

The server 10 is configured to receive the objective driving data from the on-board computer 31, detect whether the vehicle 30 exists a dangerous driving behavior in accordance with the objective driving data to generate a detection result, and determine a management strategy of the vehicle 30 in accordance with the detection result.

For example, the dangerous driving behavior include driving behaviors that may lead to traffic accidents, such as running a red light at an intersection, running a yellow light at an intersection, turning or changing lanes without a turn signal, turning left at a red light at an intersection, driving in an opposite direction on a one-way road, accelerating sharply, not slowing down at an intersection, braking too hard without obstacles, fatigue driving, etc.

In one embodiment, the server 10 can further determine driving environment information and operation information of the vehicle 30 in accordance with the objective driving data, and detect whether the vehicle 30 exists the dangerous driving behavior in accordance with the driving environment information and the operation information of the vehicle 30, to generate the detection result.

For example, the server 10 identifies that the vehicle 30 is at the intersection in accordance with the driving road images, and the traffic light at the intersection is a red light, and the vehicle 30 is recognized to be drove during the red light in accordance with the operation information, and the vehicle 30 can be determined to have a dangerous driving behavior, and the type of the dangerous driving behavior is running a red light.

The embodiments of the present application combines environmental factor of driving road to analyze the dangerous driving behavior, so that a detection result can be more reliable.

In one embodiment, the server 10 can also store the detection result of the vehicle 30 into a database. The server 10 may determine dangerous driving behaviors of the vehicle 30 within a preset time in accordance with the detection result within the preset time, give a safety score for the vehicle 30 in accordance with the dangerous driving behaviors of the vehicle 30 within the preset time and types of the dangerous driving behaviors, and determine the management strategy of the vehicle 30 in accordance with the safety score of the vehicle 30.

For example, a degree of danger of each type of dangerous driving behavior is different, and different scores can be set for the dangerous driving behaviors with different degrees of danger, and scores corresponding to the dangerous driving behaviors in the preset time can be added to obtain the safety score.

In one embodiment, the safety score can indicate a severity degree of the dangerous driving behaviors within the preset time.

For example, the higher the degree of danger of a dangerous driving behavior is, the higher the score corresponding to the dangerous driving behavior is, the higher the safety score indicates that the severity degree of the dangerous driving behaviors within the preset time.

The server 10 can also determine a recommendation priority of the vehicle 30 in accordance with the safety score of the vehicle. The higher the severity degree of the dangerous driving behaviors within the preset time indicates the lower the recommendation priority.

In one embodiment, a terminal device 40 shown in FIG. 1 can send a vehicle dispatching request to the server 10, the vehicle dispatching request includes a pick-up location. The server 10 can be used to determine a plurality of candidate vehicles 30 from the fleet 20, for example, in all vehicles 30 of the fleet 20, vehicle that are less than a preset distance from the pick-up location are taken as the plurality of candidate vehicles 30, and further determine the object vehicle 30 from the plurality of candidate vehicles 30 in accordance with the recommended priority of each of the plurality of candidate vehicles 30.

For example, the higher the recommendation priority of the candidate vehicle is, the greater the probability that the candidate vehicle is selected as the objective vehicle.

In one embodiment, the server 10 can also be used to determine whether a driver of the vehicle 30 needs to be trained with a safe driving, or rewards, or punishments in accordance with the dangerous driving behavior of the vehicle 30, so as to improve a service level of the fleet 20.

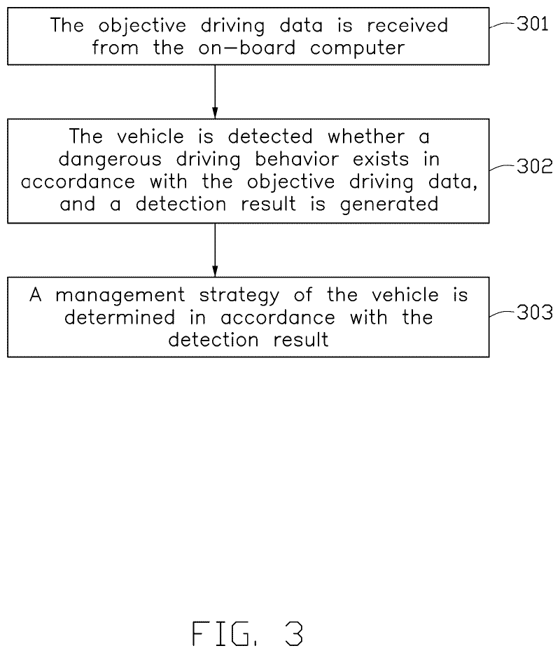

FIG. 3 illustrates one exemplary embodiment of a fleet management method. The method can be applied to a server 10 as shown in FIG. 2. The server 10 communicates with on-board computers 31 configured in vehicles 30 of a fleet 20, each on-board computer 31 can acquire objective driving data from initial driving data of a corresponding vehicle 30 and transmits the objective driving data to the server 10. The flowchart presents an exemplary embodiment of the method. The exemplary method is provided by way of example, as there are a variety of ways to carry out the method. Each block shown in FIG. 3 may represent one or more processes, methods, or subroutines, carried out in the example method. Furthermore, the illustrated order of blocks is illustrative only and the order of the blocks can change. Additional blocks can be added or fewer blocks may be utilized, without departing from this disclosure. The example method can be begin at block 301.

In block 301, the objective driving data is received from the on-board computer 31.

When an on-board computer 31 of a vehicle 30 transmits the objective driving data to the server 10, the server 10 can receive the objective driving data from the on-board computer 31 of the vehicle 30.

In block 302, the vehicle 30 is detected whether a dangerous driving behavior exists in accordance with the objective driving data, and a detection result is generated.

In one embodiment, block 302 may further include: determining driving environment information and operation information of the vehicle 30 in accordance with the objective driving data; and detecting whether the vehicle 30 exists the dangerous driving behavior in accordance with the driving environment information and the operation information of the vehicle 30, to generate the detection result.

In one embodiment, the objective driving data may include images of roads during the vehicle 30 driving, determining the driving environment information of the vehicle 30 in accordance with the objective driving data may include: inputting the images of the roads into a preset image semantic recognition model to obtain the driving environment information of the vehicle 30.

For example, the preset image semantic recognition model can identify whether a traffic light signal exists in front of the vehicle 30 in accordance with the images of the roads, classify the traffic light signal, and determine the traffic light signal is a red light signal, a green light signal, or a yellow light signal.

In one embodiment, the vehicle 30 can also be equipped with one or more radars, and the radars can detect distances between the vehicle 30 and surrounding obstacles, such as distances between the vehicle 30 and surrounding pedestrians, distances between the vehicle 30 and other vehicles, etc. The objective driving data can includes light signal information, distance information, etc., so that the driving environment information can be obtained.

In one embodiment, a dynamic scene attribute of the driving environment information can be obtain through the radars and/or the images of the roads.

In one embodiment, the objective driving data may include position information of the vehicle 30, determining the driving environment information of the vehicle 30 in accordance with the objective driving data may include: obtaining a high-precision map including the position information of the vehicle 30; and determining the driving environment information of the vehicle 30 in accordance with the position information of the vehicle 30 and the high-precision map.

For example, the server 10 can determine whether the vehicle 30 is driving on a one-way road, whether the vehicle 30 is driving at an intersection, whether the road is configured with a speed limit, and a driving direction of a lane which the vehicle 30 need to follow.

In block 303, a management strategy of the vehicle 30 is determined in accordance with the detection result.

In one embodiment, block 303 may further include: determining dangerous driving behaviors of the vehicle 30 within a preset time in accordance with the detection result within the preset time; giving a safety score for the vehicle 30 in accordance with the dangerous driving behaviors of the vehicle 30 within the preset time and types of the dangerous driving behaviors; and determining the management strategy of the vehicle 30 in accordance with the safety score of the vehicle 30.

In one embodiment, the management strategy may include a recommendation priority, the recommendation priority is determined in accordance with the safety score of the vehicle 30. After the server 10 receives a vehicle dispatching request, the fleet management method may further include: determining a first number of candidate vehicles from a second number of vehicles of the fleet 20 in accordance with a pick-up location indicated by the received vehicle dispatching request; and selecting an objective vehicle from the first number of candidate vehicles to respond the received vehicle dispatching request in accordance with the recommendation priority of each of the first number of candidate vehicles.

In one embodiment, the higher the recommendation priority of the candidate vehicle is, the greater the probability that the candidate vehicle is selected as the objective vehicle.

In one embodiment, the management strategy may include: determining whether a driver of the vehicle 30 needs to be trained with a safe driving, or rewards, or punishments in accordance with the dangerous driving behaviors of the vehicle 30 during a preset time, so as to improve a service level of the fleet 20.

For example, in order to meet a need of passengers in a hurry, a driver A1 may drive a vehicle existing a series of dangerous driving behaviors, such as frequently changing lanes to overtake, failing to keep a safe distance, violating traffic rules (such as running a red light, failure to follow lane markings), etc.

When the data collecting device 32 shown in FIG. 2 collects the initial driving data, the on-board computer 31 can screen out the objective driving data and transmit the objective driving data to the server 10. The server 10 can determine the driving environment information of vehicle 30 in combination with the objective driving data, such as determine whether vehicle 30 is at an intersection, whether a traffic light exists, a lane direction, a speed limit, etc. The server 10 can also determine the operation information of the vehicle 30 in combination with the objective driving data, such as the a driving direction of vehicle 30, a speed of the vehicle 30, etc. The server 10 can determine whether the vehicle 30 exists a dangerous driving behavior in combination with the driving environment information and the operation information, such as server 10, such as determine whether the vehicle 30 run a red light, or does not obey the speed limit.

After a statistic of a preset time, the management strategy of the vehicle 30 can be determined according to a severity of each dangerous driving behavior of the vehicle 30 during the preset time. For example, the management strategy may include recommendation priority, safe driving education, rewards, and punishments.

The on-board computer 31 of the embodiment of the present application screens out the objective driving data and uploads the objective driving data to the server 10, reducing a data amount of the driving data uploaded to the server 10, a data upload cost, and a probability of network congestion. The data amount that the server 10 needs to process is also reduced, and the computing resources of the server 10 for processing uploaded data can also be reduced. The server 10 can detect the dangerous driving behavior based on the objective driving data for managing each vehicle of the fleet.

In addition, the on-board computer 31 uploads specified initial driving data of an existence of a potential dangerous event to the server 10 as the objective driving data. That is, the initial driving data is preliminarily screened by the on-board computer 31, and the probability of detecting the dangerous driving behavior from the objective driving data is higher, the embodiment of the present application reduces the amount of data of driving data processed by the server 10, and also reduces a missing probability of the server 10 to detect the dangerous driving behavior.

The embodiment of the application also combines the driving environment information of the vehicle 30 to detect whether the vehicle 30 exists a dangerous driving behavior, and improves the accuracy of the detection of the dangerous driving behavior.

The embodiment of the application can identify the dangerous driving behavior of the vehicle for managing the vehicle, and vehicle management is more objective.

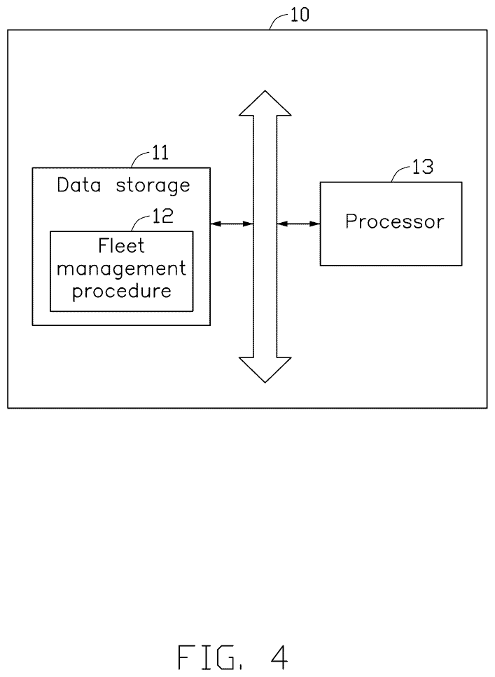

Referring to FIG. 4, a server 10 may include at least one data storage 11, at least one processor 13, and a fleet management procedure 12.

In one embodiment, the data storage 11 can be set in the server 10, or can be a separate external memory card, such as an SM card (Smart Media Card), an SD card (Secure Digital Card), or the like. The data storage 11 can include various types of non-transitory computer-readable storage mediums. For example, the data storage 11 can be an internal storage system, such as a flash memory, a random access memory (RAM) for the temporary storage of information, and/or a read-only memory (ROM) for permanent storage of information. The data storage 11 can also be an external storage system, such as a hard disk, a storage card, or a data storage medium. The processor 13 can be a central processing unit (CPU), a microprocessor, or other data processor chip that achieves the required functions.

In one embodiment, the fleet management procedure 12 may include one or more software programs in the form of computerized codes stored in the data storage 11. The computerized codes can include instructions that can be executed by the processor 13 to implement the above-mentioned of the fleet management method.

In other embodiments, comparing with FIG. 4, the server 10 can include more or less elements, for example, the server 10 can further include communication elements, buses elements.

The embodiments shown and described above are only examples. Many details known in the field are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A fleet management method applied to a server, the server communicating with an on-board computer configured in a vehicle of a fleet, the on-board computer acquiring objective driving data from initial driving data of the vehicle and transmitting the objective driving data to the server, the fleet management method comprising:
receiving the objective driving data from the on-board computer;
detecting whether the vehicle exists a dangerous driving behavior in accordance with the objective driving data to generate a detection result; and
determining a management strategy of the vehicle in accordance with the detection result.

2. The fleet management method of claim 1, wherein detecting whether the vehicle exists the dangerous driving behavior in accordance with the objective driving data to generate the detection result further comprises:
determining driving environment information and operation information of the vehicle in accordance with the objective driving data; and
detecting whether the vehicle exists the dangerous driving behavior in accordance with the driving environment information and the operation information of the vehicle, to generate the detection result.

3. The fleet management method of claim 2, wherein the objective driving data comprises images of roads during the vehicle driving, determining the driving environment information of the vehicle in accordance with the objective driving data further comprises:
inputting the images of the roads into a preset image semantic recognition model to obtain the driving environment information of the vehicle.

4. The fleet management method of claim 2, wherein the objective driving data comprises position information of the vehicle, determining the driving environment information of the vehicle in accordance with the objective driving data further comprises:
obtaining a high-precision map comprising the position information of the vehicle; and
determining the driving environment information of the vehicle in accordance with the position information of the vehicle and the high-precision map.

5. The fleet management method of claim 1, wherein determining the management strategy of the vehicle in accordance with the detection result further comprises:
determining dangerous driving behaviors of the vehicle within a preset time in accordance with the detection result within the preset time;
giving a safety score for the vehicle in accordance with the dangerous driving behaviors of the vehicle within the preset time and types of the dangerous driving behaviors; and
determining the management strategy of the vehicle in accordance with the safety score of the vehicle.

6. The fleet management method of claim 5, wherein the management strategy comprises a recommendation priority, the recommendation priority is determined in accordance with the safety score of the vehicle, the method further comprises:
determining a first number of candidate vehicles from a second number of vehicles of the fleet in accordance with a pick-up location indicated by a received vehicle dispatching request; and
selecting an objective vehicle from the first number of candidate vehicles to respond the received vehicle dispatching request in accordance with the recommendation priority of each of the first number of candidate vehicles;
wherein the higher the recommendation priority of the candidate vehicle is, the greater the probability that the candidate vehicle is selected as the objective vehicle.

7. A fleet management system, comprising one or more on-board computers and a server, the one or more on-board computers communicating with the server, each of the one or more on-board computers being configured in a vehicle of a fleet, each of the one or more on-board computers acquiring objective driving data from initial driving data of a corresponding vehicle and transmitting the objective driving data to the server, wherein the server is configured to:
receive the objective driving data from an objective on-board computer of the on-board computers;
detect whether a first vehicle configured the objective on-board computer exists a dangerous driving behavior in accordance with the objective driving data to generate a detection result; and
determine a management strategy of the first vehicle in accordance with the detection result.

8. The fleet management system of claim 7, wherein the server is further configured to:
determine driving environment information and operation information of the first vehicle in accordance with the objective driving data; and
detect whether the first vehicle exists the dangerous driving behavior in accordance with the driving environment information and the operation information of the first vehicle, to generate the detection result.

9. The fleet management system of claim 8, wherein the objective driving data comprises images of roads during the first vehicle driving, the server is further configured to:
input the images of the roads into a preset image semantic recognition model to obtain the driving environment information of the first vehicle.

10. The fleet management system of claim 8, wherein the objective driving data comprises position information of the first vehicle, the server is further configured to:
obtain a high-precision map comprising the position information of the first vehicle; and
determine the driving environment information of the first vehicle in accordance with the position information of the first vehicle and the high-precision map.

11. The fleet management system of claim 7, wherein the server is further configured to:
determine dangerous driving behaviors of the first vehicle within a preset time in accordance with the detection result within the preset time;
give a safety score for the first vehicle in accordance with the dangerous driving behaviors of the first vehicle within the preset time and types of the dangerous driving behaviors; and
determine the management strategy of the first vehicle in accordance with the safety score of the first vehicle.

12. The fleet management system of claim 11, wherein the management strategy comprises a recommendation priority, the recommendation priority is determined in accordance with the safety score of the objective vehicle, the server is further configured to:
determine a first number of candidate vehicles from a second number of vehicles of the fleet in accordance with a pick-up location indicated by a received vehicle dispatching request; and
select a second vehicle from the first number of candidate vehicles to respond the received vehicle dispatching request in accordance with the recommendation priority of each of the first number of candidate vehicles;
wherein the higher the recommendation priority of the candidate vehicle is, the greater the probability that the candidate vehicle is selected as the second vehicle.

13. The fleet management system of claim 7, wherein the objective driving data comprises driving data that exists a preset potential dangerous event in the initial driving data.

14. A server configured for communicating with one or more on-board computers, each of the one or more on-board computers being configured in a vehicle of a fleet, each of the one or more on-board computers acquiring objective driving data from initial driving data of a corresponding vehicle and transmitting the objective driving data to the server, the server comprising:
at least one processor; and
a data storage storing one or more programs which when executed by the at least one processor, cause the at least one processor to:
receive the objective driving data from an objective on-board computer of the on-board computers;
detect whether a first vehicle configured the objective on-board computer exists a dangerous driving behavior in accordance with the objective driving data to generate a detection result; and
determine a management strategy of the first vehicle in accordance with the detection result.

15. The server of claim 14, wherein when the at least one processor detecting whether the first vehicle configured the objective on-board computer exists the dangerous driving behavior in accordance with the objective driving data to generate the detection result, the at least one processor is further caused to:
determine driving environment information and operation information of the first vehicle in accordance with the objective driving data; and
detect whether the first vehicle exists the dangerous driving behavior in accordance with the driving environment information and the operation information of the first vehicle, to generate the detection result.

16. The server of claim 15, wherein the objective driving data comprises images of roads during the first vehicle driving, when the at least one processor determining the driving environment information of the first vehicle in accordance with the objective driving data, the at least one processor is further caused to:
input the images of the roads into a preset image semantic recognition model to obtain the driving environment information of the first vehicle.

17. The server of claim 15, wherein the objective driving data comprises position information of the first vehicle, when the at least one processor determining the driving environment information of the first vehicle in accordance with the objective driving data, the at least one processor is further caused to:
obtain a high-precision map comprising the position information of the first vehicle; and
determine the driving environment information of the first vehicle in accordance with the position information of the first vehicle and the high-precision map.

18. The server of claim 14, wherein when the at least one processor determining the management strategy of the first vehicle in accordance with the detection result, the at least one processor is further caused to:
determine dangerous driving behaviors of the first vehicle within a preset time in accordance with the detection result within the preset time;
give a safety score for the first vehicle in accordance with the dangerous driving behaviors of the first vehicle within the preset time and types of the dangerous driving behaviors; and
determine the management strategy of the first vehicle in accordance with the safety score of the first vehicle.

19. The server of claim 18, wherein the management strategy comprises a recommendation priority, the recommendation priority is determined in accordance with the safety score of the objective vehicle, the least one processor is further caused to:
determine a first number of candidate vehicles from a second number of vehicles of the fleet in accordance with a pick-up location indicated by a received vehicle dispatching request; and
select a second vehicle from the first number of candidate vehicles to respond the received vehicle dispatching request in accordance with the recommendation priority of each of the first number of candidate vehicles;
wherein the higher the recommendation priority of the candidate vehicle is, the greater the probability that the candidate vehicle is selected as the second vehicle.
